(19) United States
(12) Patent Application Publication
(10) Pub. No.: US 2012/0268420 A1
(43) Pub. Date: Oct. 25, 2012

(54) WRITING TABLET INFORMATION RECORDING DEVICE

(76) Inventors: Duane Marhefka, Winona, OH (US); J. William Doane, Kent, OH (US); Tod L. Schneider, Kent, OH (US)

(21) Appl. No.: 13/458,223

(22) Filed: Apr. 27, 2012

Related U.S. Application Data
(63) Continuation-in-part of application No. 12/787,843, filed on May 26, 2010.
Application No. 12/787,843 is a continuation-in-part of application No. 12/152,729, filed on May 16, 2008, now Pat. No. 8,228,301.
(60) Provisional application No. 61/554,189, filed on Nov. 1, 2011.
(60) Provisional application No. 60/962,625, filed on Jul. 31, 2007.
(60) Provisional application No. 61/181,716, filed on May 28, 2009.

(51) Int. Cl. G06F 3/045

(52) U.S. Cl. 345/174

(57) ABSTRACT

A writing/drawing tablet utilizing a data capture device such as a pressure sensitive display with data capture component that can capture data from the resulting image drawn on the device for storage. In general, Bistable Liquid Crystal Displays (BLCD), and in particular, Cholesteric Liquid Crystal Displays (ChLCDs), can be utilized in the tablet. The tablet can also be adapted to connect to external devices for displaying images being drawn on the tablet or that were previously stored.

### CROSS-REFERENCES TO RELATED APPLICATIONS

This application is a continuation-in-part of U.S. patent application Ser. No. 12/787,843, filed on May 26, 2010, which is a continuation-in-part of U.S. patent application Ser. No. 12/152,729, flied on May 16, 2008, which claims the further benefit of U.S. provisional application 60/962,625 filed on Jul. 31, 2007. Application Ser. No. 12/787,843 also claims the benefit of U.S. provisional application Ser. No. 61/181,716, filed on May 28, 2009 and U.S. provisional application Ser. No. 60/962,625 filed on Jul. 31, 2007. Furthermore, this application also claims the benefit of U.S. provisional application Ser. No. 61/554,189, filed on Nov. 1, 2011. All of these applications are incorporated herein by reference.

### BACKGROUND OF THE INVENTION

This application relates generally to a writing/drawing tablet. More specifically, this application relates to utilizing a pressure sensitive display in combination with a touch screen that can capture image data from the image being drawn on the pressure sensitive display.

In general, Bistable Liquid Crystal Displays (BLCD), and in particular, Cholesteric Liquid Crystal Displays (ChLCDs), have proven to have great potential to create low cost pressure sensitive displays that are efficient power consumers and that can be utilized in a number of unique devices. These displays use a pressure sensitive feature of the ChLCDs that allows generating an image using pressure but consuming little or no power to do so, and requiring no power to maintain the image on the display for extended periods.

Recently, the pressure sensitive cholesteric liquid crystal writing tablet, Boogie Board™ of Improv Electronics has appeared on the market in which a pointed stylus or a finger of a user can be used to write or trace an image on the surface of the tablet. Such a stylus does not transfer any ink or other material to any surface. This tablet offers a considerable improvement over previous tablet technologies in that the image can be simply and instantly erased with the push of a button that applies a voltage pulse to electrodes in the tablet. In a cholesteric liquid crystal tablet, the liquid crystal is sandwiched between two substrates that are spaced to a particular gap. The upper substrate is flexible and the bottom substrate is painted with a light absorbing (black or colored) background. The cell gap is usually set by plastic or glass spacers that are either cylindrical or spherical in shape. When one presses on the top substrate with a point stylus or finger or nail tip or other object, the liquid crystal is locally displaced. Flow induced in the liquid crystal changes its optical texture from a transparent to a brilliant reflective color at the location of the pressure. The reflective lighter color contrasts well to the dark background of the lower substrate. An image traced by the stylus or finger will remain on the tablet indefinitely until erased, typically consuming no power. Erasure is accomplished by applying a voltage pulse to transparent conducting electrodes on the inner surface of the substrates that drive the cholesteric liquid crystal from its color reflective state back to its transparent state.

The above described principle is disclosed in more detail in U.S. Pat. No. 6,104,448, incorporated herein by reference. Polymer dispersions can be used to control the pressure sensitivity and resolution of the image as described in parent U.S. patent application Ser. No. 12/152,729, filed on May 16, 2008, and incorporated herein by reference. Other modes of operation including multiple color images and select erase are described in the patent application publication given above as well as U.S. Pat. No. 8,139,039 filed on Jul. 29, 2008, and incorporated herein by reference.

It would therefore be desirable to have a writing tablet device where an image being drawn is directly observed on the drawing pad but simultaneously (or subsequently) captured electronically and digitized so as to be observed on a computer screen as well as stored for later recall and use. It would be further useful that the device be able to operate as an input device to a connected external device. Other features such as low-cost and low-power requirements would be of further advantage.

### SUMMARY OF THE INVENTION

Provided are a plurality of embodiments the invention, including, but not limited to, a writing/drawing tablet with an integrated touch screen for capturing the image written on the writing/drawing tablet into a memory; and

A writing/drawing tablet that can connect to another device for inputting drawing functionality into the other device.

Also provided are additional embodiments of the invention, some, but not all of which, are described hereinbelow in more detail.

Further provided is a 1. A drawing tablet device with data capture comprising: a drawing surface integrated in the device and adapted to display an image drawn or written upon said drawing surface by application of pressure on said drawing surface without requiring any transfer of matter to said drawing surface, and a data capture device including a data capture surface for capturing said image drawn or written upon said drawing surface for electronic capture by action other than detection of pressure within said data capture surface, wherein said display back to the user of the image drawn or written upon said drawing surface does not require the consumption of electrical power from any power source.

Also provided is a A drawing tablet with data capture comprising: a pressure sensitive drawing surface including a first substrate having at least one liquid crystal layer and adapted to display back to the user a result of an image drawn or written upon said drawing surface by application of pressure by the user to said drawing surface to locally displace said liquid crystal to change its reflectance in a persistent manner; an inductive data capture surface including a second substrate for converting said image drawn or written upon said drawing surface into data only when said image is drawn using a specialized stylus; and a memory device for storing said data, wherein said data is used for reproducing said image drawn or written upon said drawing surface.

Further provided is a drawing tablet with data capture comprising: a power supply for powering said device; a memory; a pressure sensitive drawing surface integrated in said device and including a pressure sensitive liquid crystal material, such that an image is drawn on said pressure sensitive drawing surface by providing pressure to a portion of said pressure sensitive drawing surface causing a change in state in said liquid crystal material resulting in a color change in the liquid crystal material in said portion of said pressure sensitive drawing surface for displaying the image without said pressure sensitive drawing surface consuming electrical energy; a data capture device for electronically capturing said image in said memory substantially as displayed by said drawing surface; and a data interface for connecting said device to an external device for communicating with the external device for effecting a process in the external device in real time or near real time based on said capturing.

### BRIEF DESCRIPTION OF THE DRAWINGS

The features and advantages of the examples of the present invention described herein will become apparent to those skilled in the art to which the present invention relates upon reading the following description, with reference to the accompanying drawings, in which:

FIG. 1 shows a schematic drawing of an embodiment of a writing/drawing tablet using a resistive touch screen;

FIG. 2 shows a schematic drawing of an embodiment of a writing/drawing tablet using an inductive touch screen;

FIG. 2A shows a schematic drawing of an example inductive touch screen that can be used to implement the embodiment of FIG. 2;

FIG. 3 shows a block diagram for an example writing/drawing tablet with dynamic data upload;

FIG. 4 shows block diagram for an example writing/drawing tablet with local memory;

FIG. 5 shows a block diagram for an example writing/drawing tablet with an ASIC;

FIG. 6 shows a block diagram for an example writing tablet having an additional Review Display;

FIG. 7 shows a schematic of an example writing tablet with information transfer capability connected to a user computer;

FIG. 8 shows a first example select erase function that can be provided on an example tablet;

FIG. 9 shows a second example select erase function that can be generated on an example tablet; and

FIG. 10 shows a schematic of an example writing tablet with real-time information transfer capability wirelessly connected to an external projector display.

### DETAILED DESCRIPTION OF THE EXAMPLE EMBODIMENTS

Provided are embodiments of an electronic writing/drawing tablet that has one or more of the desired features discussed above.

An electronic writing tablet as disclosed herein is a design that can be based on Kent Displays' Reflex technology as disclosed in U.S. Pat. No. 6,104,448 and in U.S. patent application Ser. Nos. 12/152,729; and 12/220,805, now issued as U.S. Pat. No. 8,139,039, all incorporated herein by reference, and which can be utilized for various embodiments of a writing/drawing tablet drawing surface modified to have a data capture feature. The reflex technology disclosed in these references makes use of the special pressure sensitivity of certain materials, in particular in a cholesteric polymer composite system, by converting the writing pressure on the display into visible track on the display. Furthermore, PCT application no. PCT/US10/36175 filed on May 26, 2010, incorporated herein by reference, discloses a related device with data capture capability. Various example embodiments of the tablet disclose several ways to integrate memory function and/or data capture functions into such writing/drawing tablets.

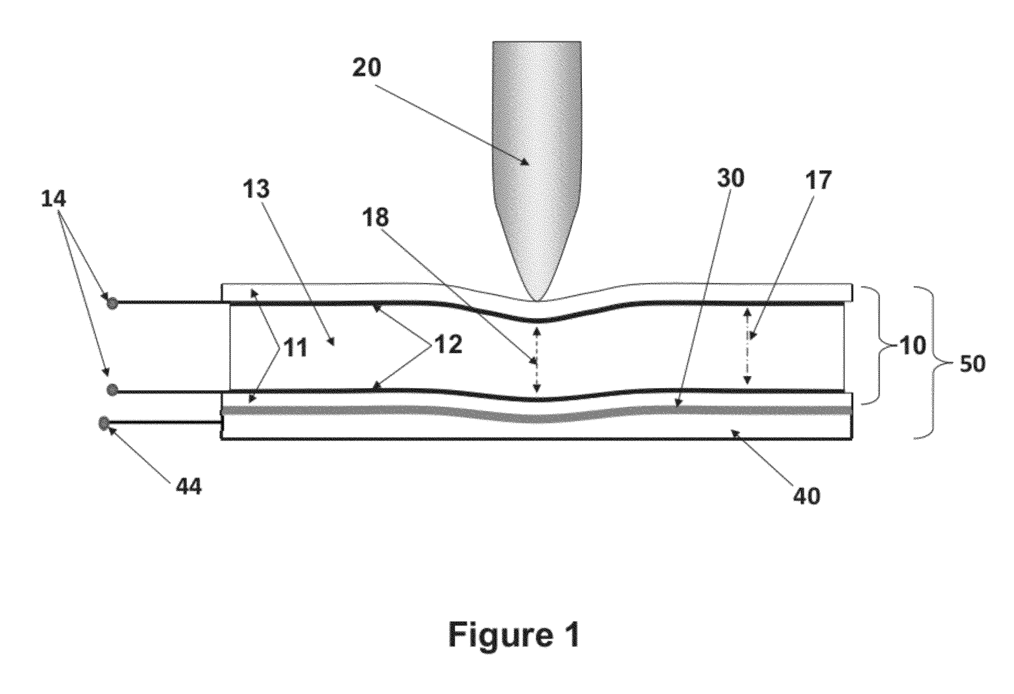

One approach is to use a state-of-the-art data capture device, such as a touch screen, to simultaneously capture the information being drawn on the tablet drawing surface. For example, a simple, low cost touch screen provided on the back of the writing/drawing surface can be utilized to capture the stylus movement by utilizing the capture features of the touch screen, as illustrated in FIG. 1, described in more detail below.

There are many touch input methods that can be used with the writing/drawing tablet as proposed herein to provide the data capture feature, such as are provided by capacitive, inductive, resistive, optical, acoustic, and other touch-input technologies. The touch screen can, for many applications, utilize relatively low resolution technology such as a low-cost resistive touch screen, and such a screen could even avoid the use of the traditional transparent conductor indium tin oxide (ITO), because it can be provided behind (underneath) the writing surface because the writing surface can be made flexible. Likewise, a touch screen behind (underneath) the writing surface is also possible with such other touch screen technologies such as the inductive (Electromagnetic Resonance (EMR)) method of at least one preferred embodiment discussed herein, since the writing surface is transparent to the inductive stylus, which can be used to apply the desired pressure to the writing surface. The resistive and inductive methods are examples of touch screen technologies that will not interfere with the intended operation of the tablet.

The writing/drawing tablet with the integrated touch screen would not likely require extensive processing capability integrated into the device itself for most such applications. The combination writing/drawing tablet drawing surface and touch screen would preferably be adapted to be connected to an external device, such as a computer or cell phone, for example, which could then provide any necessary processing capability, such as for image processing, etc. Alternatively, some minimal processing capability can also be provided in the tablet itself in order to perform some rudimentary processing functions, such as A/D conversion, minor image processing, memory management functions, communication functions, and/or display processing functions, any or all of which can be provided where desired, for example. Features controlling the transmission of stored images to an external device, or for display on an integrated review display as an additional display, can also be supported. Of course, any amount of processing can be provided by adding a more powerful processor(s) and more complex software, if desired.

The connection between the tablet and the external device can be wired or wireless, as desirable for the intended application. Thus, as examples, a wired connection, a direct wired connection, or a USB or other serial port connection could be utilized, or even an Ethernet connection for some embodiments. For wireless connectivity, a WiFi, Bluetooth, NFC, infrared, 3G, or other connection mechanism could be utilized. In some embodiments, both wired and wireless connections might be provided, although the desire to keep the cost of the tablet low, keep it small, thin and light, and the desire to reduce power consumption as far as possible might limit the number of features that one provides in some embodiments of the tablet. A minimal tablet with just those features needed to operate the device and internally store and/or transfer images to external devices thus may be a preferred example embodiment.

An interface can be provided on the tablet to connect the tablet to an external device. Such an interface can use custom protocols, or make use of any of several commercially available standards. For example, implementing the USB Mass Storage class will permit images saved on the tablet to appear in the file system of a host computer, while the USB Human Interface Device class may be used to present the tablet as a digitizer input device or a mouse to an external host computer or other device. Additionally, a Wintab driver could be written for the tablet, such that any application written to the Wintab specification could use the tablet as an input device. Similar standards exist for Bluetooth as well, such as the File Transfer Profile and the Human Interface Device Profile. Thus, the processor of the tablet might be adapted to manage a file system in the tablet memory to support such functions.

For many applications, it is desirable to reduce the cost of the recordable writing/drawing tablet significantly by utilizing the processing capability of the external device, whenever possible. Of course, when desirable, the processing capability could be integrated into the tablet itself for applications where an external device is either not expected to be available, or does not have sufficient processing capability for the intended application(s), or to provide a more self-contained tablet more like a computer.

Thus, the tablet could have a processor (such as a microcontroller, CPU, or other type of processor) incorporated therein to provide sufficient processing in the device. Dedicated processors for implementing the desired interface (e.g., USB, Ethernet, WiFi, Bluetooth, near-field, etc.) could be utilized, and may be available off-the-shelf with either commercially available, or customized, software/firmware. The atom processor line from Intel is one example low-power processor that might be used.

Alternatively, or in addition, a dedicated processor, controller, ND device, or other electronics might be provided to digitize, filter, or otherwise modify the image drawn on the tablet, and such devices are known to be used with some touch screen applications and some are commercially available.

Furthermore, the tablet might incorporate a memory device, such as RAM, flash, EEPROM, a hard drive, or other data storage mechanism, to store images drawn on the display within the device for later download to a computer or other device. Such a memory could enable the device to store hundreds, or even thousands or more images in the memory. Such memory devices might be removable, such as a USB drive or flash memory card commonly available for digital photography and music storage, for example. An example preferred embodiment of the tablet includes a slot for insertion of commercially available removable flash memory. Thus, in some embodiments, removable memory might avoid the need for tablet connectivity to external devices, as the memory can be removed to be used in other devices, instead.

As discussed above, there are many data capture options, including many touch input methods, that can be used with writing tablets to obtain data capture functionality, such as pressure sensitive touch screens, inductive touch screens (such as Electromagnetic Resonance (EMR) touch screens), optical touch screens, acoustic touch screens, capacitive touch screens, and others.

One preferred example embodiment utilizes an inductive (EMR) touch screen with a specialized stylus. An example of such a touch screen device that might be utilized for such an embodiment is given in U.S. Pat. No. 5,136,125, incorporated herein by reference.

In such an embodiment, the touch screen is placed underneath the drawing pad, and thus does not interfere with the drawing and display process and hence does not require expensive transparent components. The inductive touch screen inductively (electromagnetically) detects the presence of the specialized stylus sufficiently near the touch screen in any one of a number of different ways that can be used. One manner of detection is that the specialized stylus is provided with a tuned circuit that oscillates and thereby communicates electromagnetically with a “detector” on the touch screen, which detects this oscillation. The stylus is either powered using an internal battery, or preferably it is powered electromagnetically by receiving power from the touch screen itself, such as electromagnetically (e.g., inductively). Depending on how close the stylus is to the touch screen, or how far the user presses the stylus tip into the screen (such as for a stylus with an adjustable tip), a wider or narrower width line might be detected electronically as the stylus is moved across the drawing surface. For example, a wider line might be determined when an adjustable tip is pressed into the screen, bringing the tuned circuit closer to the touch screen detector, and thus presenting a more powerful (or more coupled) connection.

However, as discussed in more detail below, in the inductive touch embodiment, the electronic version of the image is detected (to be electronically stored and/or transferred) independently of the drawn image, as the former detects electromagnetic coupling between the tuned circuit and the detector, whereas the latter uses pressure from the stylus on the writing surface to display an image. Nevertheless, when properly balanced, the two both capture very similar or identical images, and thus the user is none the wiser.

In at least some embodiments, the stylus of an inductive touchscreen can be detected even when it does not quite touch the drawing surface, in which case stylus movements might be electronically captured but nothing drawn on the pressure display. This can be useful when using the stylus to control a cursor on an attached device for implementing specific functions, and it might be desirable in other situations as well. By pressing the stylus harder (deeper) into the drawing surface, a thicker line can be both drawn on the drawing surface (due to the increased pressure of the stylus), and a thicker line can also be detected by the touch screen due to the tip of the stylus (or the electromagnetic components) being closer to the touch screen, or via the relative position of the stylus tip within the stylus (e.g., which could result in the adjustment of a variable LC circuit in the stylus that can be detected). Thus, line width can be similarly or identically adjusted in both the displayed, and the electronically captured, images.

Note that in the above embodiment using an inductive touch screen and the specialized stylus, data is only captured by the touch screen when the specialized stylus is used. Thus, if one draws on the drawing surface of the tablet using a finger, or a non-specialized stylus or pen or pencil, for example, the result is that an image can be drawn on the drawing surface for viewing, but no data is collected by the inductive touch screen, and thus no corresponding electronic image is captured. This could be utilized to allow users to draw on the drawing surface without use of the stylus, but the user cannot capture the drawing electronically in such circumstances. This might be desirable in some situations. However, if it is desired to capture the drawing electronically, the specialized stylus should always be used in such cases. Thus, replacement specialized styluses can be made available, where the original may have been lost or damaged.

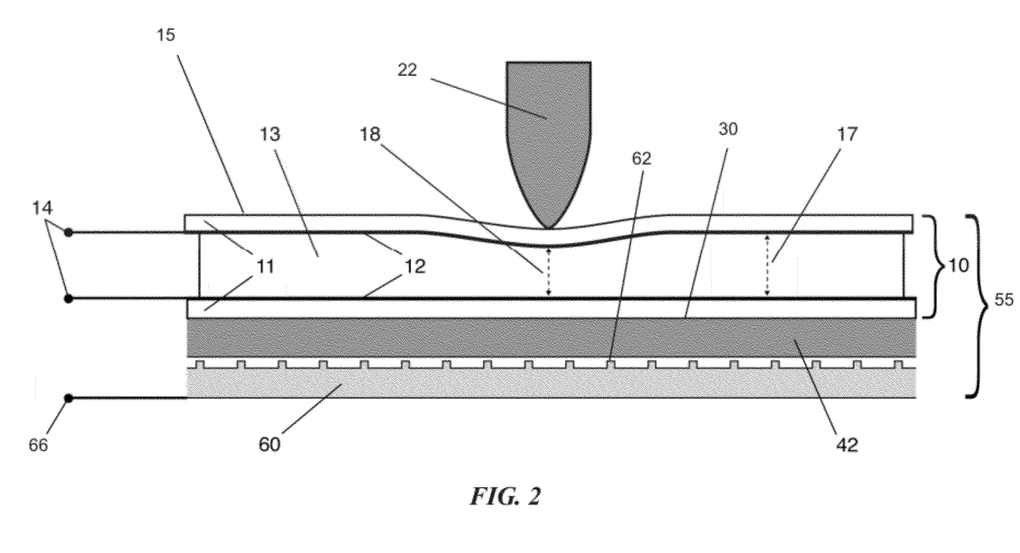

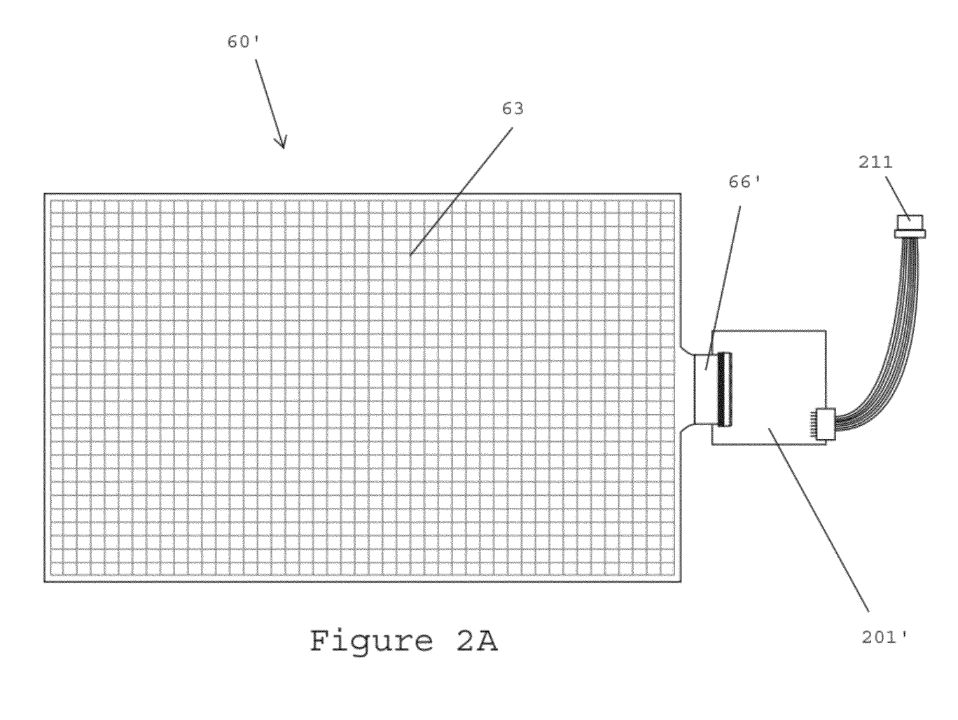

FIG. 2 shows a schematic of the layers of the drawing pad with an integrated inductive touch screen of a data capture device. The inductive touch screen 60 is a data capture surface that is placed underneath the drawing pad 10 to provide an integrated writing and recording surface 55. FIG. 2A shows a specific example of such a touch screen 60′ with the grid surface 63 facing up with connector 66′ for connecting to data capture controller electronics 201′ that are further connected to internal tablet electronics by connector 211.

Again referring to FIG. 2, a plastic separator sheet 42 of flat material is provided between the touch screen 60 and the drawing pad 10 to “planarize” the surface of the touch screen 60, which in many examples is not completely smooth due to the presence of a wire grid 62 crisscrossing the surface of the touch screen 60 for sensing the presence of the inductive stylus (e.g., as detectors, and, in some cases, for providing power electromagnetically to the stylus). This plastic separator sheet 42 is used to prevent images of the wire grid 62 of the touch screen from appearing in the display during use (i.e., prevent “bleed through” due to the pressure sensitivity of the drawing pad display to pressure), especially in situations where a large portion of the screen might be contacted and gently pushed, such as by a hand, for example.

Alternative approaches to preventing “bleed through” might use a coating over the touch screen surface, rather than the plastic sheet. Coatings, for example, may be used that are blade coated or otherwise coated as a liquid then subsequently cured or hardened to a smooth surface. Sprayable or spreadable materials that can be gelled or hardened, such as paint, adhesives, potting material, etc., may also be used and might further serve an additional function such as gluing the layers together. Alternatively, a sheet with indentations that match and accept the wire grid 62 might also be used.

Typically, it is desirable to have the entire thickness of the device as thin as possible, in particular less than 1 cm thick in a preferred embodiment. Clearly, the thinner the drawing pad 10, the easier for the touch screen to detect the stylus (as the tuned circuit can be closer to the detectors). Also, thinner separator sheet layers are desirable, with thicknesses of 2.35 mm for injection molded ABS to 1.4 mm of acrylic working well, although thicknesses on the order of a few thousandths of an inch may be desirable wherever practical.

The drawing pad 10 of this example embodiment has a writing surface 15 and includes two flexible substrates 11, each with transparent conductive electrodes, 12 located on the inner surface. A pressure sensitive cholesteric liquid crystal dispersion, 13, rests between the electrodes 12. The data capture device includes a specialized stylus 22. Pressure from the stylus, 22, creates a smaller gap distance 18 in the drawing pad 10, compared to the relaxed distance 17, which causes the liquid crystal to flow and change the cholesteric texture from a transparent focal conic texture to a reflective, stable planar texture which becomes a visible image to the eye when contrasted on a dark, usually black background as provided by a light adsorbing layer, 30. Thus, the image is drawn on the writing surface and displayed to the user without the consumption of electrical power, as the image is formed by the distortion of the liquid crystal caused by the stylus pressure, and the image is persistent due to the bistable nature of the liquid crystal. Thus, the image remains when the pressure is removed.

In the case of an inductive touch screen of this example embodiment, pressure from the tip of the specialized stylus 22 is utilized by the user to draw on the writing surface 15 to create an image. At the same time, stylus location information is transferred through the drawing pad 10 to the touch screen 60 by electromagnetic interaction of the specialized stylus 22 and the wire grid 62 of the touch screen, by determining the position or location of the stylus (or the tuned circuit located therein, or an antenna located therein) as location data. There is no need to use pressure information of the stylus in the touch screen to determine the location data in an inductive approach. This location data from the touch screen is transferred to touch pad electronics (not shown) via electrodes 66. There can be a plurality of electrodes 66 depending upon the type of inductive touch screen utilized.

As described, for example, in U.S. Pat. Nos. 4,786,765 and 5,135,125 herein incorporated by reference, inductive touch screens utilize a special stylus, such as one that includes the tuned circuit of an inductor and capacitor connected in series. The stylus is typically provided without connection to a power supply or other device, but has a resonant frequency approximately equal to the frequency of a wave derived from a coil arrangement in a tablet. The position of the stylus on the tablet is detected by coupling energy induced in the stylus back to the electrode grid on the tablet. In a commercially available Waltop device, the Sensor Board, Control Board, and UART connection can be used to communicate with the tablet MCU Device.

Another example embodiment utilizes a pressure sensitive touch screen for the data capture feature, whereby the location of the stylus is recorded by its location on a resistive pad provided on the back side of the drawing surface of the writing tablet, as illustrated in FIG. 1. In FIG. 1, a stylus, 20, provides pressure to the electronic writing tablet drawing surface 10 in a manner similar to that discussed above with respect to FIG. 2.

For this alternative embodiment, the pressure sensitive touch screen 40, is placed adjacent to the writing tablet 10 to provide an integrated writing and recording surface 50. The writing tablet is similar to that described above for FIG. 2, using transparent electrodes 12 on flexible substrates 11 with a liquid crystal material 13 provide between. In the case of a pressure sensitive touch screen such as a resistive one, pressure from the stylus 20 is transferred through the drawing pad 10 to the touch screen 40 at 18, indicating its position or location on the touch screen. The relaxed state is shown at 17. The resistive data from the touch screen is transferred to digital recording electronics via electrodes 44. There can be a plurality of electrodes 44 depending upon the type of resistive touch screen utilized. This particular embodiment can be provided at a relatively low cost, is relatively simple, and can be made very thin and light in weight. A commercial touch screen can be used in this embodiment or it can be custom designed to be better integrated with the writing tablet. Alternative embodiments can utilize other types of touch screen technologies.

Of course, in some alternative embodiments, the image could be provided as a negative of the above described process by providing a light reflective light background that becomes transparent in response to the stylus pressure under an applied voltage exposing a dark light absorbing background. Either embodiment can be used to display an image due to the contrast between the background and the portion of the liquid crystal that was deformed by the pressure, thereby producing the desired image.

In still other embodiments, a digital camera or other optical capture device can be utilized to capture the image instead of the touch screen. The camera or image sensor may be one such as in a hand carried portable phone with processing capability to identify and capture only the writing surface of the tablet containing the image then displaying the image on the display screen of the phone as well as storing it in memory for later viewing.

For any of the above embodiments, the entire image may be erased by applying voltage pulses to the electrodes 12, via the interconnects 14, such as disclosed in U.S. Pat. No. 6,104,448 and U.S. patent application Ser. Nos. 12/152,862 and 12/220,805, incorporated by reference. In the example embodiments, these pulses are applied when the erase function is activated, either by pressing an “erase” button, or receiving an erase command from a connected device, or by some other method. In preferable embodiments, electrical power is required by the drawing pad 10 only for erasing the image and putting the liquid crystal back into a neutral state for receiving the next drawing image. There is little or no power consumption during the drawing phase using the above described embodiment. However, electrical power will typically be required for the touch sensor to capture the image data electronically, when this functionality is enabled.

Alternative embodiments may utilizes some electrical power for the drawing process, such as for various contrast improving functions, providing a negative mode (e.g., mode A discussed below), or partial (selective) erasing, as discussed below, but generally it does not require any power to maintain a stable image on the display itself due to the bistable nature of the liquid crystal utilized for the device.

In additional example embodiments with data capture features, using any of the methods and designs disclosed above, the tablet device senses the drawing operation during the drawing process (via the data capture method such as a touch screen) and temporarily stores this data into a memory device (which can preferably be integrated into the device itself, or alternatively could be provided in an external device). Upon the activation of a capture switch, such as a push button (or continuously or at specified time intervals if automatic capture is desired) the device, or an external device, converts the data stored in the memory into a file that is also stored in memory to “capture” the current image. This capture process using a capture switch is like taking a snapshot of the current image for storage. Then, the user can continue to draw on the device to modify the current image, and, if desired, capture additional images by activating the capture switch. In this manner, the progressive changes to an image can be captured by the user. Of course, at any time the user can erase the current image, and start the process all over again.

In additional embodiments, time information might also be captured during the image capture. Thus, the time of each image capture might be stored with the image, or time may be associated with individual data elements from the data capture device. For instance, (x, y, t) data might be captured, with x being one linear dimension coordinate, y being a perpendicular linear dimension coordinate, and t being the time the coordinate is drawn or captured. By storing time information, an image or sequence of images might be redrawn in a proper order piece by piece (and perhaps mapped to an audio recording, such as to recreate a presentation or lecture, for example), or an animation created by the image drawing process, or for some other purpose.

Generally, as one draws on the drawing surface (using the proper stylus, if required), the touch screen interface tracks that drawing and streams drawing data to a processor, where the data is converted and stored in memory. For bitmapped file formats, such as BMP, PNG, or TIFF, the streaming data will typically be rendered to an image buffer in RAM. When the image is “captured” the data can be formatted and compressed as specified by the file format and committed to flash. For vector file formats, such as PDF, WMF, EMF, SVG, or CGM, the streaming data can be committed directly to flash or optionally compressed and stored in RAM to be transferred to flash later when the image is “captured”. One method used for such storage is to utilize the vector graphics features of Adobe® Acrobat® as the compressed format that is stored into RAM.

Note that for embodiments using a specialized stylus (such as the inductive touch screen embodiment shown in FIG. 2 and discussed above), only when that stylus is used for creating the drawing is data captured electronically. If an image is drawn in some other manner not using the specialized stylus, the capture process will fail to capture the image. Furthermore, if part of the drawing is done using the specialized stylus, but another part is drawn in some other manner, then only that portion drawn by the specialized stylus will be electronically captured. This feature can be used for special purposes, such as to capture images that are substantially different than images shown on the screen, for any number of reasons, such as to not capture an initial rough sketch of a drawing, for example. Similar functionality could also be implemented by providing a means to temporarily disable the touch sensor, such that something may be drawn on the screen without capturing it to memory even when using the specialized stylus, if desired.

In a preferred embodiment, the captured images are stored as Adobe® Acrobat® (pdf) files in a memory in the device. This is done by finalizing the Acrobat file when the capture switch is activated (adding any required overhead to the file) and then saving the file in the flash memory for later viewing or transfer by the user. In at least some preferable embodiments, this captured image cannot be reproduced on the drawing surface of the device subsequent to the original image being erased, and thus must be transferred to another device for viewing. Such a device without reproduction capability is greatly simplified, as the drawing surface need not incorporate display reproduction capability which would add cost, complexity, and mass.

However, in other embodiments, the device provides the capability of displaying the image on the drawing surface by providing a means of electrically drawing images on the drawing surface, such as by using technologies for changing the state of the liquid crystal layer, such as disclosed in U.S. Pat. Nos. 5,889,566 or 5,644,330. Alternatively, the image might be “drawn” on the display by using technologies that will utilize the pressure sensitivity of the drawing surface, such as by utilizing piezoelectric affects, for example.

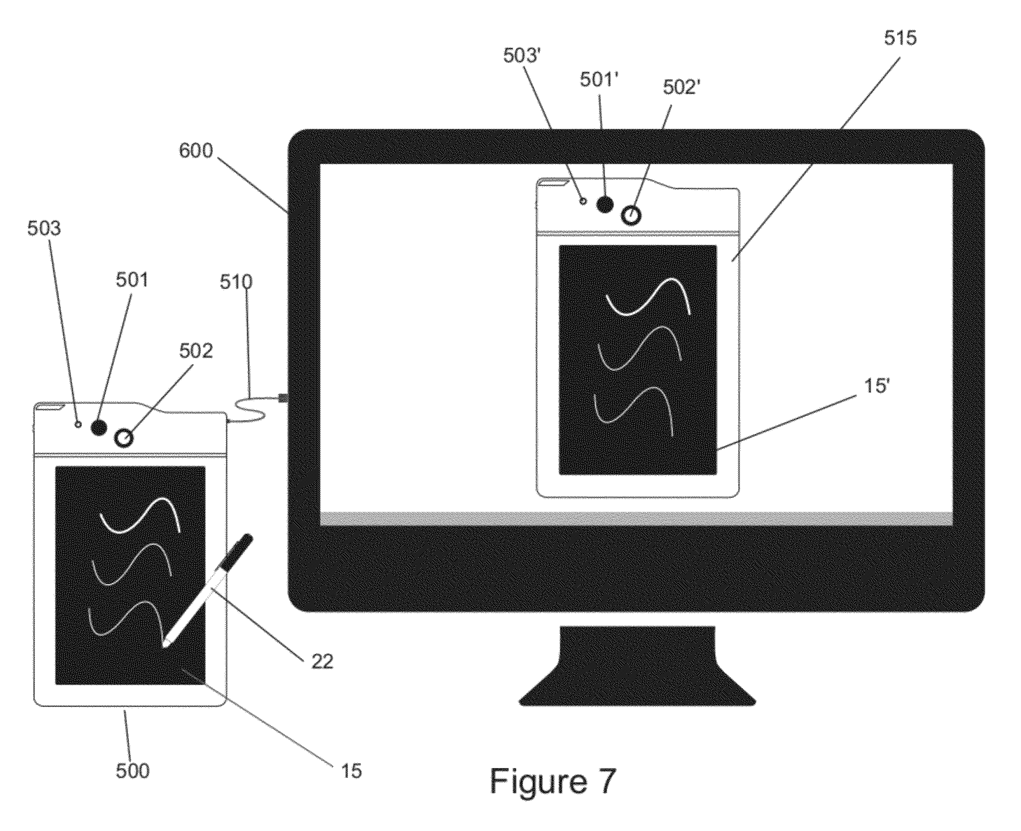

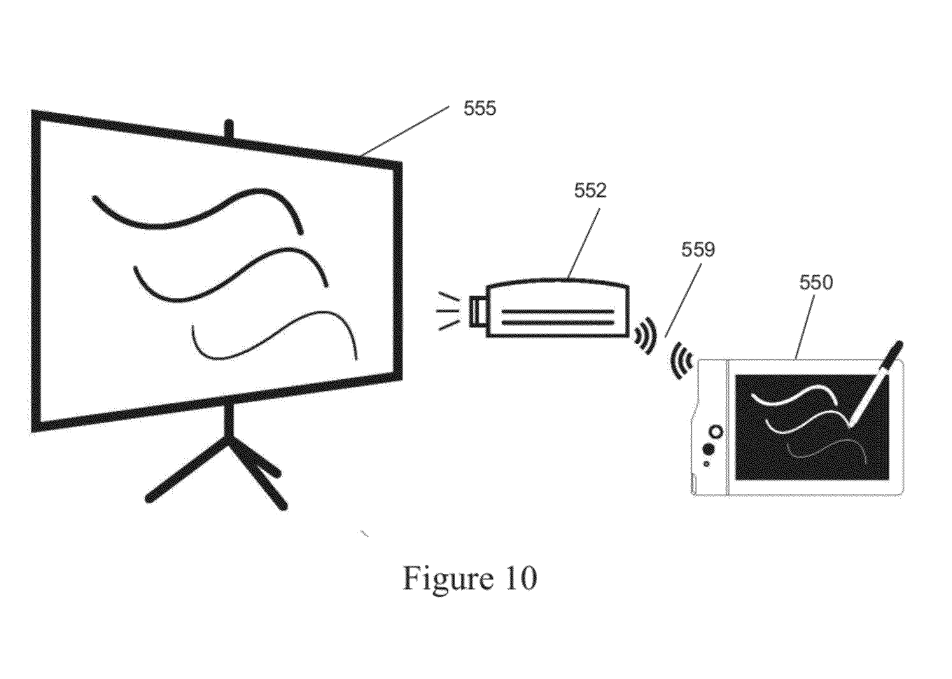

The captured drawing (image) can be sent to a desktop PC, laptop, PDA, or cell phone via a wireless or a wire link (see FIGS. 7 and 10, described below). The flash storage on the device can be accessed on the remote device in a manner similar to how flash memory plugged into such a device is treated, e.g., it can be shown as a storage device and the stored Acrobat files accessed in the normal manner such files would be accessed. Another option is to store the captured image on local flash memory, or internal memory, of the device itself. Several different designs for the inventive device to perform this function are described in more detail, hereinbelow.

With the consideration of the compactness integration, durability, low power, and convenience of use, any of the following embodiments of the tablet, among others, could be provided to capture the image drawn on the tablet on an external device:

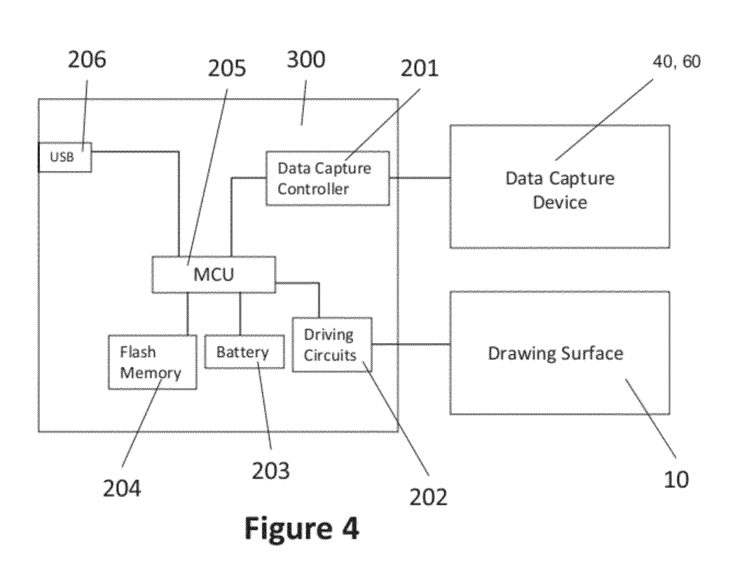

The general design of an example embodiment that is compact and economical is shown in the block diagram in FIG. 4. It includes a writing/drawing surface 10, a data capture device such as a pressure (e.g., resistive) touch screen 40 or an inductive touch screen 60. Associated circuitry 300 includes a data capture controller 201 that receives the data from the touch screen 40 or 60 for providing (such as by streaming data) to a general purpose microcontroller unit, a general purpose MCU 205 having RAM, tablet drive circuits 202 for erasing images on the drawing surface 10 (as described in more detail, above), a rechargeable battery 203 for powering the electronics and erase function, flash memory 204 or other memory, and a USB port 206 for connecting to external devices, and for charging the rechargeable battery 203.

The flash memory 204 may be removable, such as by using a USB flash drive or other types of removable flash memory commonly used in the computer industry, such as compact flash, memory stick, MicroSD, MMC, etc. or an internal hard drive such as might be used in a laptop computer, for example. Alternatively, the memory 204 may be omitted, with the tablet relying on the memory of the external device connected via the USB, for example, to save on mass, power, and costs, in which case images could be streamed to the external device. However, this would likely require that the tablet device be tethered to the external device for most drawing operations to save drawing iterations, which may not be desirable in many circumstances.

The touch screen 40, 60 is integrated with writing/drawing tablet 10 to form a combined writing/recording surface 50, 55 for the tablet, as illustrated in FIGS. 1 and 2, respectively. These components are then integrated together in housing to form the tablet (see, e.g., item 500 in FIG. 7). Writing or drawing on the drawing surface 10 is sensed by resistive data capture device 40, or inductive data capture device 60 (but only if drawn using the specialized stylus, where applicable), or alternatively by some other capture method, and the captured data is converted by the touch screen controller 201 into coordinate data that is streamed to and captured by the MCU 205. Typically, the image data is captured and stored in RAM on the fly until the user activates a switch to capture the image in the local flash memory 204 for storing an image, such as a pdf file as described in more detail, above. The image files may then be transferred an external device, such as PC, laptop, PDA, projector, or cell phone (discussed in more detail below) via the USB port 206. If appropriate, the flash memory 204 may be removed (such as an SD Card) to transfer data to an external device.

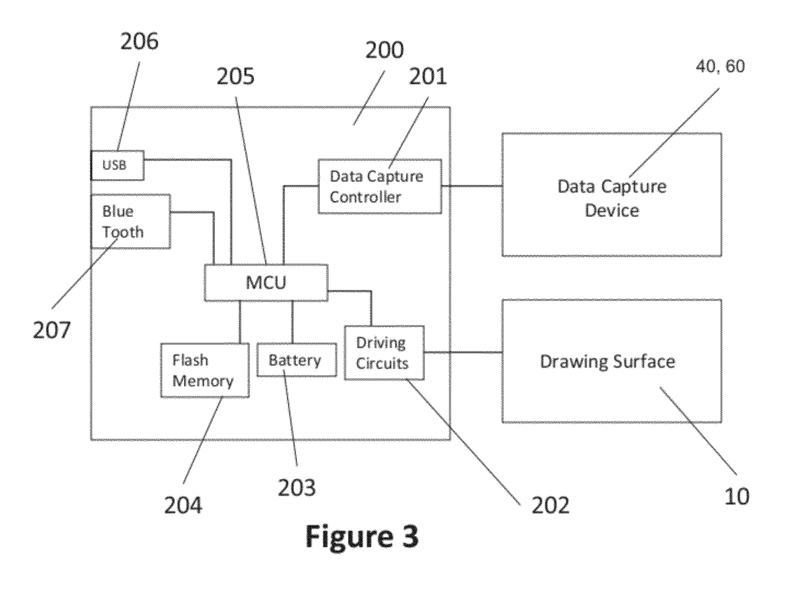

Another example embodiment is shown in FIG. 3 adding wireless capability, such as the Bluetooth interface 207 or a near-field interface for very short range communications, such as to a cell phone or PDA. It includes a writing/drawing tablet 10, a data capture device such as a pressure sensitive touch screen 40 or an inductive touch screen 60, and associated electronic circuitry 200. A blue tooth port 207 can be used for connecting to external device, such as PC, laptop, PDA or cell phone (not shown). Alternate circuitry 200, as shown in FIG. 4, can be provided without external wireless capability to simplify the device even further.

Furthermore, the images stored in the memory might be replayed by the tablet through an external display (e.g., a projector), or an additional review/preview display integrated with the tablet. For example, a scroll button could be provided that will scroll through the stored images and redraw them on the external or preview display, without downloading the entire set of images.

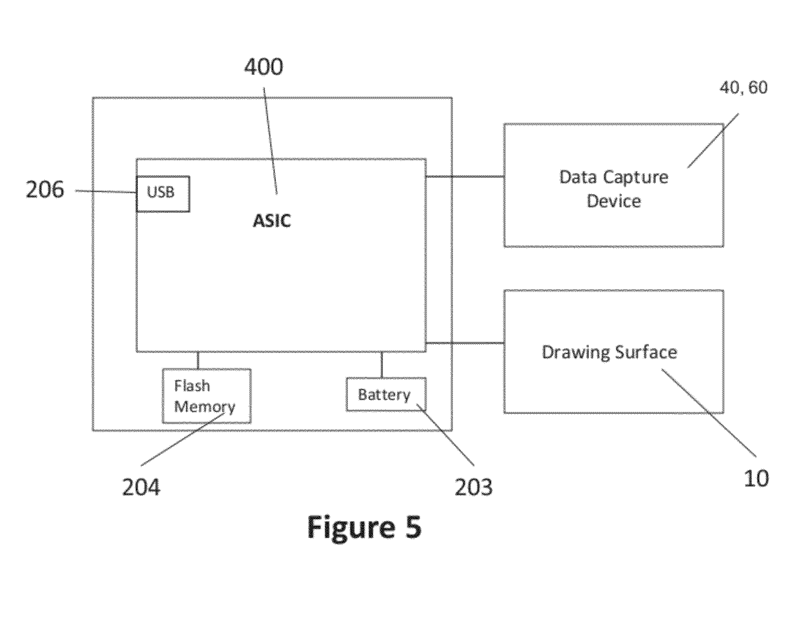

To further reduce the cost and improve reliability, the MCU 205, UBS port 206, touch screen controller 201, and driving circuits 202 can be replaced with one customized integrated circuit 400 (ASIC), as illustrated in FIG. 5.

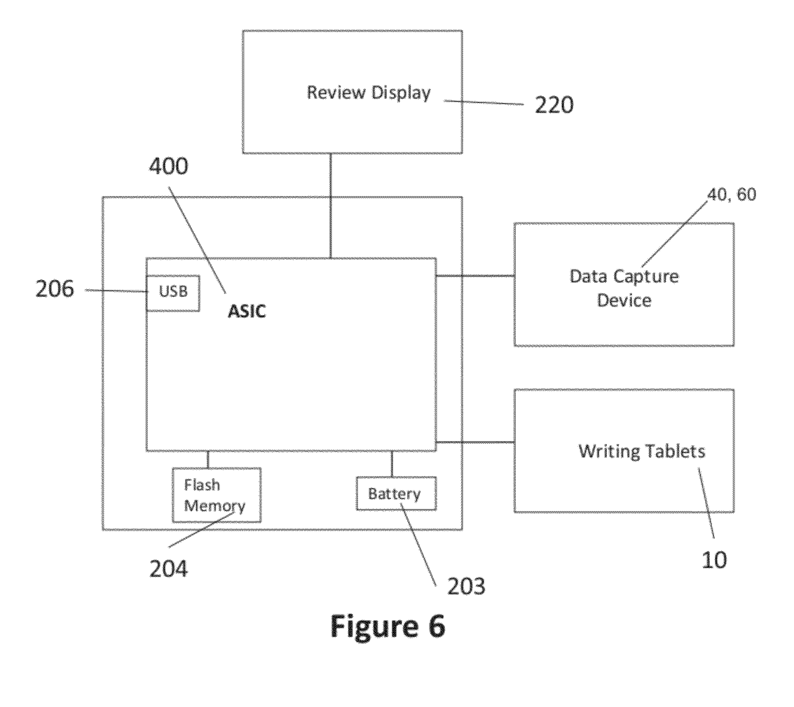

A display 220 can be added to any of the embodiments of the device, such as a small format display (such as 2.5″ TFT, for example), for page review/preview, such as is illustrated in FIG. 6 for the ASIC embodiment of FIG. 5. Such a display could also be used to scroll through the images stored in the tablet. Thus, a more functional tablet with the display 220 can be provided in alternative embodiments.

The battery 203 in FIGS. 3, 4, 5, and 6 in the design could utilize a rechargeable Li-Poly battery (or other rechargeable technology) and/or solar cell, which could be used for charging an additional rechargable battery. The Li-Poly battery can be charged by a solar cell or by a USB port, for example. Such a design might last for years without any changes or replacement parts. It is a true “green” design.

Example Devices

FIG. 7 shows an example drawing device tablet 500 with capture capability that is connected to a computer 600 via USB interface 510. The user draws on the drawing surface 15 of the tablet 500 using the specialized stylus 22, that might be using an inductive touch screen capture capability. This example drawing tablet 500 has two interface buttons, an erase button 501 and a capture/wake button 502. Indicator 503 lets the user know both when the device is active (such as by a steady glow), and when the device is capturing an image (such as by flashing, for example). In order to save power, the device has a sleep mode where it will shut down the touchscreen and capture electronics in order to reduce power consumption. The user can wake the device by pressing the capture/wake button 502. Also, when the user wants to capture the current image on the device, the user can push the capture/wake button 502 to trigger the capture process. A lock switch can also be provided that will lock the image on the drawing surface so that it cannot be erased until the lock switch is released. Of course, separate buttons could be used for the capture and wake functions, if desired. Note that variable line widths are shown on both the tablet 500, and the virtual display 515, which are provided in a manner as discussed in more detail hereinabove.

On the computer 600, an application can be provided that allows the user to see in real-time (or near real-time such that the delay time is unnoticeable or negligible) on virtual screen 15′ the same image that is being drawn on the drawing device 500 (as long as the image is drawn using the specialized stylus 22), as shown by the graphical representation 515 of the device 500. The virtual erase button 501′ and virtual wake/capture button 502′ can be made to operate in the same manner as the corresponding physical buttons on the device 500 by activating the virtual buttons using a mouse cursor, for example. The virtual indicator 503′ can give the user an indication of the device operation in a manner similar to the indicator 503.

Alternatively, rather than drawing the image on the computer 600 in real time, the tablet 500 could instead have the computer 600 draw the image only after the capture button 502 is pushed to capture the image. Such functionality could be made user selectable on the tablet 500 or the computer 600.

Additional features that can be provided on the computer interface include allowing the view and other settings of the virtual device 515 to be adjusted, such as by using a pop-up window. Another interface window can be used for the user to select whether to locally save the image on the virtual screen, or to email the image using an email application, or to perform some other function with the image. The image files stored in the flash memory of the tablet device 500 may be accessed for copying, opening, deleting, etc. as are files on any removable disk.

An application running on the computer (such as could be provided for installation with the drawing device 500, or be made available for download) can provide a system tray for easy accessibility to the various functions of the device, including a battery capacity indicator for showing the available capacity of the rechargeable battery of the device 500 and a device icon. An indicator showing when the device is not connected can also be provided.

Note also that a color drawing feature described in the cited applications could also be utilized for a drawing tablet with data capture. Also, selective erasure of portions of the drawing also described in that application, could also be utilized for the tablet with data capture features.

The tablet device is thus made useful as a drawing device on a PC, because it is easier to draw with a stylus while looking at the pressure sensitive display than it is to draw on a tablet device while looking up at the PC monitor. Hence, providing a localized image on the drawing surface provides a distinct advantage over devices that cannot do so.

Furthermore, the connection can be adapted for using the stylus for general mouse functionality, such as dragging and dropping rather than drawing, in which case it may not be desirable to see such actions drawn on the drawing pad. In order to prevent such actions from drawing on the drawing pad, the drawing surface could first be erased and then the select erase functionality (described in more detail below) would be kept in an enabled state. Thus, everything drawn by the stylus will match the background color and not be visible. Depending on the mode of operation, a voltage may be required across the drawing pad electrodes while the select erase functionality is enabled. Alternatively, a higher voltage waveform could be continuously applied to the drawing pad electrodes that erases the entire drawing surface to the focal conic (dark) state, or a yet higher voltage waveform that holds the liquid crystal of the entire drawing surface in a homeotropic state could be used.

Also, a low-cost device that is always tethered to a PC could omit the battery and flash for an additional example embodiment.

Select Erase Capability

U.S. patent application Ser. No. 12/787,843, filed on May 26, 2010, and incorporated herein by reference, discloses a design for a multi-color dual-mode drawing pad 10 that allows for selective erasure of drawn images, rather than requiring erasing the entire image as discussed above. In this design, a “mode A” is provided where using pressure of a pointed stylus, an image is drawn on the pad via the liquid crystal in the focal conic state against the background liquid crystal in the planar state, and a “mode B” is provided where, using pressure, a color image is drawn on the pad via the liquid crystal in a planar state against the background liquid crystal in the focal conic state. Mode B may be considered as the negative image of Mode A. In the above described embodiment without selective erase, the primary mode of operation is mode B.

This multi-mode approach can be used in another example embodiment of the instant device by using only two colors, a foreground color and a background color, to both draw and erase images on the drawing pad. In such a device, portions of a drawing displayed on the drawing pad that was drawn using one mode can be erased by changing the mode of operation to the other mode, and then writing the background color over the drawing, essentially erasing the drawn image as described in more detail in U.S. Pat. No. 8,139,039

Hence, for example, a device using the dual-mode operation may operate for normal drawing in mode B, which requires no voltage across the drawing pad (i.e., across the liquid crystal via electrodes 12 of writing tablet 10 of FIGS. 1 and 2) during the drawing operation using pressure, such as via the tip of the stylus. Since this reduces the power consumption during the drawing process it is normally the preferred mode of operation.

However, if the user desires to erase a part of the displayed image, the drawing pad can be transitioned to mode A for selective erasure wherein voltage is applied to electrodes 12 of writing tablet 10 during the erasure process. This might be done by activating a push switch or other actuator provided on the device, or by activating some menu item or actuator on a remote device with which the tablet is connected, or by sensing some change to the stylus, or by activating a switch on the stylus, either of which can cause a change in the detected resonance circuit of the stylus, causing the tablet to change its mode of operation from mode B to mode A.

Then, the user can erase the desired portion of the displayed image by applying pressure to that portion of the image (such as by using the stylus eraser tip, or even the user's finger, for example). Essentially, the user is overwriting the drawn portion of the image with the background color, thereby erasing that portion of the image. The tablet can then be put back into mode B for further drawing. This can be done by using the manual actuator, or by sensing that the stylus has returned to the drawing tip orientation, for example.

Such a device would still have an erase capability for erasing the entire image, as described above. Generally, no voltage is provided across the liquid crystal for drawing during mode B, whereas a voltage must be applied across the liquid crystal when drawing in mode A, and hence power can be conserved by utilizing mode B for most of the drawing operation, which consumes no power at all (in contrast to mode A, which does consume power during the writing or erasure process. However, once an image is written or erased in Mode A, voltage to electrodes 12 of FIGS. 1 and 2 is not required to display the resulting image. The voltage put across the liquid crystal for selective erasure is substantially lower than the voltage used to completely erase the image (e.g., ˜5V vs. ˜20V).

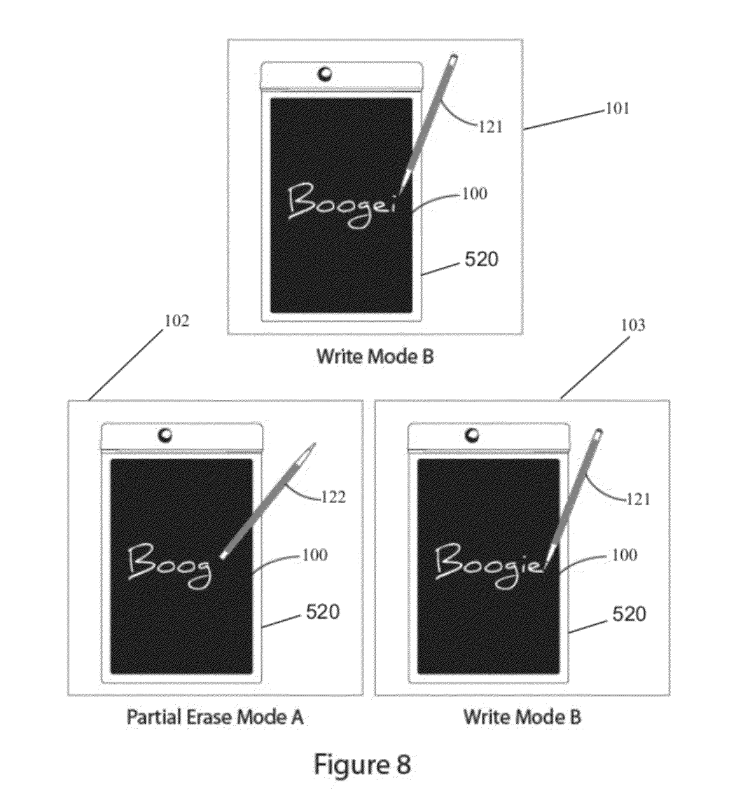

FIG. 8 shows an example embodiment of a tablet 520 implementing this above described capability. In image 101, the normal mode B is provided for drawing on the tablet 100 using the stylus placed in such an orientation 121 that the drawing tip of the stylus is in contact with the tablet drawing surface. Image 102 shows the tablet transitioned to mode A for erasing part of the image using the erasing end of the stylus in orientation 122, and image 103 goes back to the normal drawing mode using the drawing tip of the stylus back in orientation 121.

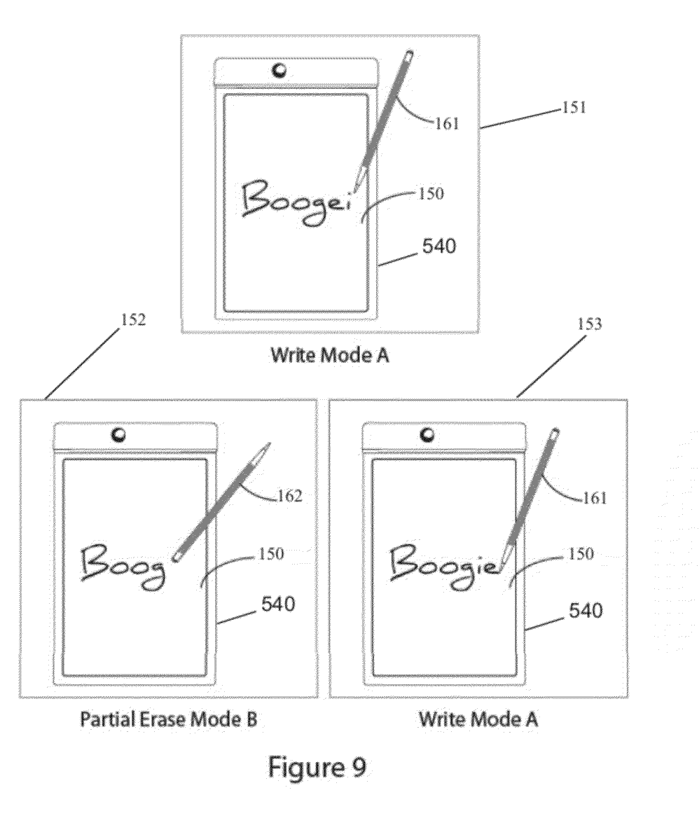

As an alternative, drawings could be done using mode A and erasures using mode B. FIG. 9 shows such an alternative example for a tablet 540. In image 151, the normal mode A is provided for drawing on the tablet 150 using the stylus placed in such an orientation 161 that the drawing tip of the stylus is in contact with the tablet drawing surface. Image 152 shows the tablet transitioned to mode B for erasing part of the image using the erasing end of the stylus in orientation 162, and image 153 goes back to the normal drawing mode using the drawing tip of the stylus back in orientation 161.

Such selective erasures can be captured electronically in a similar manner. Once the tablet knows that it is in an erasure mode, images drawn on the tablet that are sensed by the touch screen underlying the drawing pad, there are a number of ways to capture the erasure electronically. For example, erased portions of a “new” image in the background color can be used to overwrite the original image in the background color, thereby erasing the desired portion of the original image. This is particularly useful if the images are stored using vector graphics. Alternatively, if the original image is stored as a bitmap, either a new overwriting bitmap can be used, or the original bitmap can be modified to show the erasure.

The above concept can be modified such that the tablet can display images in color using multiple layers of liquid crystal, as discussed in the Ser. No. 12/787,843 application. In such embodiments, any of the layers could be independently operated in mode A or mode B, leading to a number of permutations of modes to allow for a very complex set of color drawing and erasing capabilities.

Input Device Applications:

Alternative embodiments of the tablet device described herein could be utilized such that the table device operates as an input device to support various products and services.

For one example, the drawing tablet device can be utilized as an input device for connecting to a computer for use in various computer applications. For example, the device might operate a curser as a mouse, digitizer, or trackball interface, such that the drawing device can be used to select various computer functions, such as selecting menus and activation buttons, for example. Furthermore, the device could interface with drawing software, such that rather than using a trackball or mouse, the user, such as using a cursor, for example, can draw using the drawing application. The user could select the current color in the application and then draw images using the cursor to utilize the drawing functions of the drawing software installed on the computer.

The tablet drawing device could even be adapted to allow for drawing lines of varying thickness. For example, by pressing harder on the drawing surface, the stylus is closer to the inductive touch pad of the tablet drawing device, and this closer position could be detected by the electrode grid and thus be translated into thicker lines. Another alternative including using a variable LC circuit in the stylus, such that pushing in a moveable tip on the stylus changes the resonance of the LC circuit (such as by changing settings on a variable capacitor, variable inductor, or variable resistor, for example), which can be interpreted as different line widths. Such a variable LC could also be used to modify functionality on the computer, such as a push in operating as a mouse click, and a lesser push in having a different function, for example. Alternatively, multiple styluses having different resonant frequencies could be utilized for different functions, such as for activating certain colors, line thicknesses, filling in shapes, etc.

Or, the device might interpret the speed of the stylus across the drawing surface as indicating an intended line thickness, such that faster drawing speeds lead to thinner lines, and slower drawing speeds lead to thicker lines, for example.

The recorded line thickness may be tuned based on one or more of pressure, speed, or temperature to match the thickness of the line drawn on the display.

As another alternative, the tablet drawing device could be utilized as an input device for providing presentations on computer screens, projector screens, tablets, electronic white boards, etc. such that a lecturer or other presenter could use the device for real-time communication, much like a white board or chalk board can be used by a teacher for writing mathematical equations, for example. This is similar to the application shown in FIG. 7 and described above, except that the tablet would not necessarily write to a virtual version of the tablet, but would be used to write to the large display for viewing by the audience, as shown in FIG. 10, where the tablet 550 is shown wirelessly connecting 559 to the projector 552 for projecting an image on the screen 55 for displaying images drawn on the tablet 550 by the user directly on the screen 555.

In such an embodiment, it is desirable that the image drawn on the tablet 550 be displayed on the screen 555 in real time, or near real time, such that there is little delay in displaying the image on screen 555. To accommodate such real-time or near real-time display, it may be desirable to directly stream drawing data from the tablet 550 to the projector 552, as any intervening step, such as first storing the image in memory on the tablet, could interfere with the real-time drawing of the image on the screen 555. Note that variable line widths are shown on both the tablet 550, and the screen 555, which are provided in a manner as discussed in more detail hereinabove.

Hence, either the memory storage function could be completely eliminated in this embodiment, or the streaming of the drawing data to the projector 552 could be done prior to memory storage, or in parallel, so that no significant delay in the streaming of the data occurs.

Such presentation formats using the above embodiment or alternatives thereof might include displaying such images on electronic whiteboards, televisions, or other display types. Furthermore, networked computers or remotely located projectors could be utilized, so that people in remote locations can view the results on local monitors or screens, such as supporting videoconferencing, for example. The advantage of having a local screen for the presenter is that the presenter can see the image on the input device (the tablet) as it is being drawn, and thus more easily continue where they left off, a shortcoming of many existing products. Modifications of such a tablet might be to change the aspect ratio of the tablet to better match that of the display screen, or allow the tablet orientation to be changed based on the display screen.

Many other example embodiments of the invention can be provided through various combinations of the above described features. Although the invention has been described hereinabove using specific examples and embodiments, it will be understood by those skilled in the art that various alternatives may be used and equivalents may be substituted for elements and/or steps described herein, without necessarily deviating from the intended scope of the invention. Modifications may be necessary to adapt the invention to a particular situation or to particular needs without departing from the intended scope of the invention. It is intended that the invention not be limited to the particular implementations and embodiments described herein, but that the claims be given their broadest reasonable interpretation to cover all novel and non-obvious embodiments, literal or equivalent, disclosed or not, covered thereby.

What is claimed is:

1. A drawing tablet device with data capture comprising:
a drawing surface integrated in the device and adapted to display an image drawn or written upon said drawing surface by application of pressure on said drawing surface without requiring any transfer of matter to said drawing surface, and
a data capture device including a data capture surface for capturing said image drawn or written upon said drawing surface for electronic capture by action other than detection of pressure within said data capture surface, wherein
continued display of the image that was drawn or written upon said drawing surface does not require the consumption of electrical power from any power source.

2. The device of claim 1, further comprising an interface for connecting to an external device, and wherein said image is transferred to the external device for display and/or storage.

3. The device of claim 1, wherein said drawing surface comprises a pressure sensitive LCD for displaying the image drawn or written on the drawing surface.

4. The device of claim 3, wherein said LCD is a Cholesteric LCD.

5. The device of claim 4, wherein said drawing surface may be operated in a first mode where electricity is not required while drawing or writing an image on the drawing surface, and wherein said drawing surface may be operated in a second mode, where electricity is required while drawing or writing an image on the drawing surface.

6. The device of claim 3, wherein drawing or writing of the image on the drawing surface is accomplished without use of any electricity to display the image during said drawing or writing.

7. The device of claim 3, wherein said displaying back of the image drawn or written on the drawing surface is accomplished without use of any electronics.

8. The device of claim 1, wherein said pressure is applied to said drawing surface using a specialized stylus.

9. The device of claim 8, wherein said data capture device is adapted to convert locations of the specialized stylus to electrical signals for capturing said image drawn or written upon said drawing surface into a memory device.

10. The device of claim 1, wherein said data capture device comprises an inductive touch screen device utilized for capturing said image drawn or written upon said drawing surface into a memory device.

11. The device of claim 1, wherein said data capture device includes RAM for temporarily storing drawing data during a drawing operation and also includes a flash memory for storing the drawing data stored in said RAM when an actuator is actuated.

12. The device of claim 1, further comprising a data interface, wherein a memory device included in an external device communicating with said tablet device utilizes said data interface for capturing said image, wherein said memory device is used to reproduce the image on a remote display provided with said external device.

13. The device according to claim 1, further comprising an additional display for displaying a replica of the image.

14. The device of claim 13, wherein said tablet device is adapted such that additional images previously stored in said tablet device can be displayed on said additional display when selected by the user for such display.

15. The device according to claim 1, further comprising an erase actuator, such that activation of the erase actuator erases the image drawn or written upon said drawing surface by application of a voltage to said drawing surface.

16. The device according to claim 1, further comprising a capture actuator, such that activation of the capture actuator causes said device to store the image currently displayed on the drawing surface.

17. The device according to claim 1, further comprising a processor for processing the image captured by said data capture device prior to storing said image in a memory device or prior to transferring said image to an external device.

18. The device according to claim 1, further comprising a memory device for storing said image prior to transfer to an external device.

19. The device according to claim 1, further comprising a removable memory device for storing said image captured by said data capture device.

20. The device according to claim 1, further comprising an interface for connecting to an external device, wherein said image is transferred to the external device by the drawing tablet device for display by the external device in real time or near real time as the image is drawn on said drawing surface.

21. The device according to claim 20, further comprising a memory for storing the image captured by said data capture device.

22. The device according to claim 21, further comprising a capture actuator, such that activation of the capture actuator causes said device to store the image currently displayed on the drawing surface in said memory.

23. The device according to claim 1, wherein a portion of the image can be selectively erased by changing a mode of operation of said drawing surface and applying pressure to the portion of the image that is to be erased.

24. The device according to claim 1, wherein said drawing surface is adapted for displaying an image that has been previously stored in memory.

25. The device according to claim 1, wherein said drawing surface is comprised of a plurality of stacks of drawing surfaces each for displaying a different color.

26. The device according to claim 25, wherein each of said plurality of stacks can be independently operated in one of two operating modes, one for drawing images without use of power, another for drawing images requiring the use of power.

27. The device of claim 1, wherein said drawing surface may be operated in a first mode or a second mode wherein the image of the second mode is a negative of the image in the first mode.

28. The device of claim 1, further comprising a data interface for connecting said device to an external device for communicating with said device for effecting a process in said external device in real time or near real time based on said capturing.

29. The device of claim 1, wherein in another mode of operation, a different image drawn or written upon said drawing surface by application of pressure on said drawing surface is displayed in a background color such that said different image is not visible.

30. A drawing tablet with data capture, comprising:
a power supply for powering said device;
a memory storage device;
a pressure sensitive drawing surface integrated in said device and including a pressure sensitive liquid crystal material, such that an image is drawn on said pressure sensitive drawing surface by providing pressure to a portion of said pressure sensitive drawing surface causing a change in state in said liquid crystal material resulting in a color change in the liquid crystal material in said portion of said pressure sensitive drawing surface for displaying the image without said pressure sensitive drawing surface consuming electrical energy;
a first switch for erasing said image in its entirety from said drawing surface by providing electrical energy to said drawing surface when said switch is actuated by a user;
an inductive data capture device for electronically capturing said image in said memory substantially as displayed by said drawing surface when using a specialized stylus for providing said pressure; and
a data interface for connecting said device to an external device for communicating with said device for displaying the image captured electronically on a display of said external device.

31. The drawing tablet according to claim 30, wherein a portion of the image can be selectively erased from said pressure sensitive drawing surface by changing a mode of operation of said drawing surface and applying pressure to the portion of the image that is to be erased.

32. The drawing tablet according to claim 31, wherein the same portion of the image electronically captured can also be selectively erased.

33. The writing tablet according to claim 30, wherein no data is captured electronically if the image drawn on said drawing device is drawn not using said specialized stylus.

34. A drawing tablet with data capture, comprising:
a pressure sensitive drawing surface including a first substrate having at least one liquid crystal layer and adapted to display back to the user a result of an image drawn or written upon said drawing surface by application of pressure by the user to said drawing surface to locally displace said liquid crystal to change its reflectance in a persistent manner;
an inductive data capture surface including a second substrate for converting said image drawn or written upon said drawing surface into data only when said image is drawn using a specialized stylus; and
a memory device for storing said data, wherein said data is used for reproducing said image drawn or written upon said drawing surface.

35. A drawing tablet with data capture, comprising:
a power supply for powering said device;
a memory
a pressure sensitive drawing surface integrated in said device and including a pressure sensitive liquid crystal material, such that in at least one mode of said tablet, an image is drawn on said pressure sensitive drawing surface by providing pressure to a portion of said pressure sensitive drawing surface causes a change in state in said liquid crystal material resulting in a color change in the liquid crystal material in said portion of said pressure sensitive drawing surface for displaying the image without said pressure sensitive drawing surface consuming electrical energy;
a data capture device for electronically capturing said image in said memory substantially as displayed by said drawing surface; and
a data interface for connecting said device to an external device for communicating with the external device for effecting a process in the external device in real time or near real time based on said capturing.

36. The drawing tablet of claim 35, wherein in at least one other mode of operation, said tablet communicates with the external device for effecting the process in the external device based on said capturing without drawing a visible image on said pressure sensitive drawing surface.

37. A drawing tablet with data capture, comprising:
a power supply for powering said device;
a pressure sensitive drawing surface integrated in said device and including a pressure sensitive liquid crystal material, such that an image is drawn on said pressure sensitive drawing surface by providing pressure to a portion of said pressure sensitive drawing surface causing a change in state in said liquid crystal material resulting in a color change in the liquid crystal material in said portion of said pressure sensitive drawing surface for displaying the image without said pressure sensitive drawing surface consuming electrical energy;
an data capture device for electronically capturing said image in said memory substantially as displayed by said drawing surface; and
a data interface for connecting said device to an external device for communicating with said device for displaying the image captured electronically on a display of said external device in real time or near real time.

38. A drawing tablet with data capture, comprising:
a power supply for powering said device;
a memory storage device;
a pressure sensitive drawing surface integrated in said device and including a pressure sensitive liquid crystal material, such that when said pressure sensitive drawing surface is placed in a first mode of operation, an image is drawn on said pressure sensitive drawing surface by providing pressure to a portion of said pressure sensitive drawing surface causing a change in state in said liquid crystal material resulting in a color change in the liquid crystal material in said portion of said pressure sensitive drawing surface for displaying the image without said pressure sensitive drawing surface consuming electrical energy;
a first switch for erasing said image in its entirety from said drawing surface by providing electrical energy to said drawing surface when said switch is actuated by a user; and
a data capture device for electronically capturing said image in said memory substantially as displayed by said drawing surface, wherein
a portion of the image can be selectively erased from said pressure sensitive drawing surface by placing said pressure sensitive drawing surface in a second mode of operation and applying pressure to the portion of the image that is to be erased.

39. The tablet according to claim 38, wherein the same portion of the image electronically captured can also be selectively erased.
